(19) United States
(12) Patent Application Publication
(10) Pub. No.: US 2009/0072765 A1
(43) Pub. Date: Mar. 19, 2009

(54) Method for Controlling Multi-colored Light Fixtures

(76) Inventor: Richard Mark DeBock, Clayton, NC (US)

Correspondence Address: Richard M. DeBock, 1320 Pine Trail, Clayton, NC, 27520, US

(21) Appl. No.: 11/840,018

(22) Filed: Sep. 13, 2007

(51) Int. Cl. H05B 41/38

(52) U.S. Cl. 315/325

(57) ABSTRACT

This invention is a control panel and a compatible circuit which is used for controlling the color and intensity of multi-colored light fixtures. The panel consists of a saturated color mixing control source, a white level control source, and a brightness control source. The circuit consists of a control panel interface that converts and processes the control panel inputs into signals that can be used to control multi-color lighting fixtures.

### BRIEF DESCRIPTION OF DRAWINGS

FIG. 1 shows an implementation of the Control Panel (1) and Circuit (5). For this implementation the Control Panel is the same size as a standard switch plate used for home and office lighting. The two concentric circles above and below item (2) show the countersunk screw holes.

FIG. 2 shows how item (7) of the circuit uses the touched position on item (2) to mix any two colors of a three color system (red, green, blue—RGB). The rectangles at the bottom of the intensity graphs represent a linear view of item (2).

FIG. 3 shows how item (7) of the circuit may be expanded to control a four color light fixture (red, yellow, green, blue—RYGB). The rectangles at the bottom of the intensity graphs represent a linear view of item (2).

### BACKGROUND OF THE INVENTION

Lighting in homes, offices, automobiles, and other equipment and locations is limited by the color of the light source, which is typically supplied by a fluorescent or incandescent bulb. Some Light Emitting Diode (LED) light fixtures are also limited to a single color. Multi-colored LED arrays, however, provide the ability to generate custom colors for a variety of purposes. These LED arrays tend to be limited to use in the arts or industrial complexes and require skilled operators or technicians to control them using computers and associated software.

The object of this invention is to provide an intuitive means for one who is unschooled in the art of color management to be able to control the color and intensity of a multi-colored light source. Intuitive control of multi-colored light sources is a requirement to make such light sources usable and desirable by the general public.

Future multi-colored light sources will typically be composed of red, green, and blue LED's which operate more efficiently than incandescent lights. This invention should speed the incorporation of these LED light sources into homes and offices thereby reducing electrical energy demands and overall lighting costs.

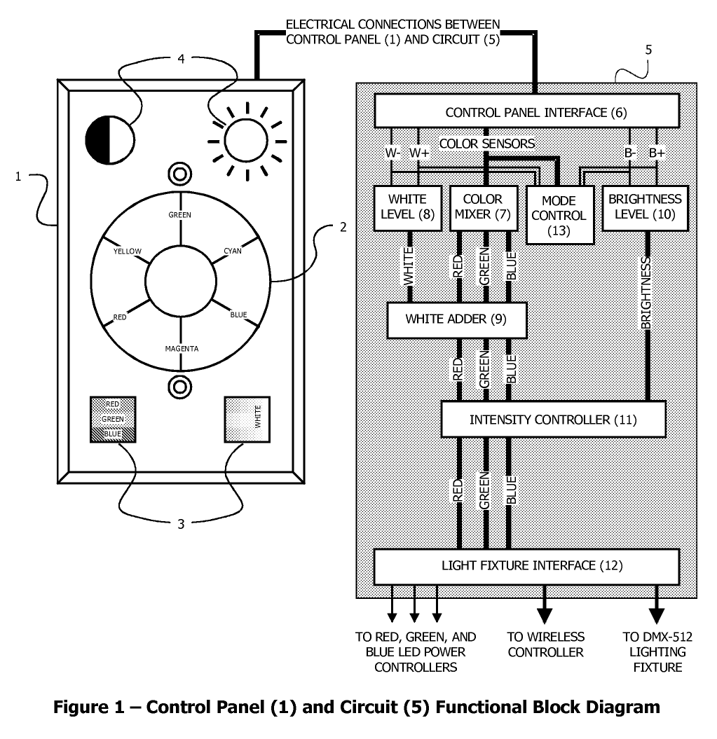

The invention consists of a Control Panel (1) which allows a person to control the color and intensity of a multi-colored light source by a Circuit (5) that interprets the user inputs from the control panel (FIG. 1). These two items are described in greater detail in the following paragraphs.

### Control Panel (1)

The control panel is an electric field sensing device that supplies the inputs to the Circuit (5) using a Color Mixing Control (2), White Control (3), and Brightness Control (4).

### Color Mixing Control (2)

A person uses the color mixing control to vary the light color prior to the addition of white level. This particular implementation of the color mixing control consists of six electric field sensors centered about the color-labeled spokes of the control circle. The sensor design allows for a single finger to contact up to two sensors at a time. This happens, for example, when a finger is placed mid-way between the red and yellow sensors, mid-way between the yellow and green sensors, and so forth. Note that with the six electric field sensor scheme any one of twelve colors can be activated due to absolute finger position. Many more colors are possible using the touch protocols of the Color Mixer (7).

More than one finger may be used on the color mixer such that three or more sensors are touched, or sensors on opposite sides of the color mixing control are being contacted. These conditions are used to define special functions as described in the Mode Control (13) section.

To further enhance the intuitive nature of the Color Mixing Control the color labeled fields are replaced by their actual labeled saturated colors. For example, the spoke labeled, RED, is colored red. The spoke labeled, YELLOW, is colored yellow. The colors mix going from the RED to the YELLOW spokes changing from red, to orange at the mid-point between the RED and YELLOW spokes, to yellow at the yellow spoke. The same type scheme follows around the rest of the color fields from YELLOW to GREEN to CYAN to BLUE to MAGENTA and back to RED.

### White Level Input (3)

The two square sensors at the bottom of the Control Panel (1) add or subtract white from the color mix result provided by the Color Mixing Control (2). Touching the right square sensor tells the Electrical Circuit (5) to add white (decreases color saturation). Touching the left square sensor tells the Electrical Circuit (5) to subtract white (increases color saturation). To further enhance the intuitive nature of the controls the left square sensor is colored with saturated red, green, and blue stripes. The right square sensor fades these stripes left to right from light red, green and blue to white.

### Brightness Control (4)

The two round sensors at the top of the Control Panel (1) tell the Circuit (5) to increase the brightness by touching the right sensor or decrease the brightness by touching the left sensor. To further enhance intuitiveness the brightness control uses the commonly accepted symbols of a half moon for dimming and the sun for brightening.

### Circuit (5)

The circuit may be implemented using analog, digital, or a mix of both analog and digital design methods. It may also use a computing device such as a digital signal processor, micro-computer, or micro-controller, and applicable software. This implementation uses analog sensing to determine which Control Panel (1) sensors are being touched, and it uses digital techniques everywhere else. The signal flow of the circuit is from top to bottom [Control Panel Interface (6) to Light Fixture Interface (12)]. The following paragraphs describe the functions of each of the blocks of the circuit.

### Control Panel Interface (6)

The Control Panel Interface periodically tests each sensor of the Control Panel (1) to determine if zero, one, or more than one sensor is being touched and passes this information on to the next blocks in the signal flow as shown in FIG. 1. If any of the color sensors of the Color Mixing Control (2) are being touched that information is passed on as the COLOR SENSORS signals. If either of the White Level Input (3) sensors is being pressed that information is passed on as W− and W+, with W− representing the touching of the left square sensor, and W+ representing the touching of the right square sensor. If either of the Brightness Control (4) sensors is being touched that information is passed on as B− and B+, with B− representing the touching of the left round sensor, and B+representing the touching of the right round sensor.

### Color Mixer (7)

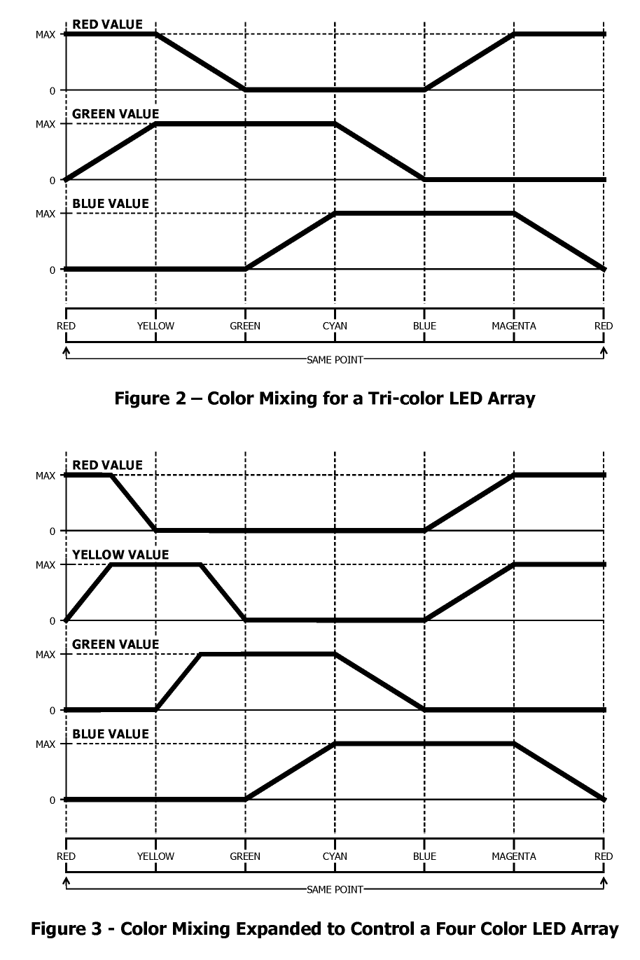

The Color Mixer keeps a record of prior scans deep enough to determine if the color sensors experienced a single tap, double tap, continuous touch without movement, or continuous touch with movement to adjacent sensors. The Color Mixer ignores scans in which Color Control (2) sensor combinations are activated that are impossible using a single finger. It also maintains a record of its current mixed color output values of RED, GREEN, and BLUE, which it passes on to the White Adder (9). Each of these registered values is eight bits wide in the current implementation, but they may be any width. FIG. 2 shows the Color Mixer algorithm for the RED, GREEN, and BLUE output signals.

If the Color Mixer detects a double tap on the Color Mixing Control (2) it immediately sets the red, green, and blue outputs to produce the color indicated at the point of the Color Mixing Control (2) where the double tap occurred. For example, a double tap at the mid-point between blue and magenta results in blue at its maximum, red at one half its maximum value and green at zero (see FIG. 2). The resulting color combination passed on to White Adder (9) is purple. The combination of the Color Control (2) and Color Mixer (7) allows a double tap to any of twelve colors.

If the Color Mixer detects a single tap on the Color Mixing Control (2) it immediately moves the current color one unit closer to the color indicated at the point of the Color Mixing Control (2) where the single tap occurred.

Pressing and holding a finger on one sensor or two adjacent sensors of the Color Mixing Control (2) causes the Color Mixer to assume the continuous touch without movement mode. In this mode the current color moves closer to the color indicated on the Color Mixing Control (2) at a predetermined rate. Movement stops when the current color matches the one represented by the finger placement on the Color Mixing Control (2), or the finger is lifted. If the user moves his finger to an adjacent sector without lifting it from the Color Mixing Control the color mixing changes to continuous touch with movement.

Pressing a sensor on the Color Mixing Control (2) and then moving the finger to an adjacent sensor causes the Color Mixer to assume continuous touch with movement mode. In this mode of operation the Color Mixer moves the current color one unit for each sensor crossed and follows the same direction as the finger movement without regard to the current color displacement from the touched color sensor. Stopping and holding the finger on the Color Mixing Control (2) will cause the Color Mixer to change modes to continuous touch without movement.

Note that either of the continuous touch modes may be entered from the Color Mixing Control (2), a moving finger to stationary finger, or a stationary finger to a moving finger, as long as the finger is not lifted from the Color Mixing Control (2). If finger contact is removed from the Color Mixing Control (2) the continuous touch mode ends and color changes stop.

### White Level (8)

The White Level keeps a record of scans deep enough to determine if the White Level sensors (3) experienced a single tap, double tap, or a continuous touch. It also maintains a record of its current white value which it also passes on to the White Adder (9). The white value in this implementation is stored as an eight bit value.

A double tap on the vivid color (left) sensor clears the WHITE signal to zero. A double tap on the white (right) sensor sets WHITE to its maximum value. Touching both sensors at the same time sets WHITE to one half of its maximum value. Continuously touching the left sensor causes WHITE to decrement at a predetermined rate stopping when WHITE is zero or the finger is lifted from the sensor. Continuously pressing the right sensor causes WHITE to increment at a predetermined rate stopping when WHITE is at its maximum value or the finger is lifted from the sensor.

### White Adder (9)

This block accepts the RED, GREEN, and BLUE inputs from the Color Mixer (7) and sums them with WHITE from White Level (8) to generate new values of RED, GREEN, and BLUE which it passes on to the Intensity Controller (11). If adding WHITE to the RED input results in a carry being generated, the RED output is limited to its maximum value. Otherwise, the RED output is the sum of the RED input plus the WHITE input. If adding WHITE to the GREEN input results in a carry being generated, the GREEN output is limited to its maximum value. Otherwise, the GREEN output is the sum of the GREEN input plus the WHITE input. If adding WHITE to the BLUE input results in a carry being generated, the BLUE output is limited to its maximum value. Otherwise, the BLUE output is the sum of the BLUE input plus the WHITE input.

### Brightness Level (10)

The Brightness Level keeps a record of scans deep enough to determine if the Brightness sensors (4) experienced a single tap, double tap, or a continuous touch. It also maintains a record of its current brightness value which it also passes on to the Intensity Controller (11). BRIGHTNESS in this implementation is stored as an eight bit value.

A double tap on the half moon (left) sensor clears the BRIGHTNESS signal to zero. A double tap on the sunshine (right) sensor sets BRIGHTNESS to its maximum value. Pressing both sensors at the same time sets BRIGHTNESS to one half of its maximum value. Continuously touching the left sensor causes BRIGHTNESS to decrement at a predetermined rate stopping when BRIGHTNESS is zero or the finger is lifted from the sensor. Continuously pressing the right sensor causes BRIGHTNESS to increment at a predetermined rate stopping when BRIGHTNESS is at its maximum value or the finger is lifted from the sensor.

### Intensity Controller (11)

This block multiplies each of the three RED, GREEN, and BLUE inputs by the quantity, BRIGHTNESS+1, to generate new RED, GREEN and BLUE values to the Light Fixture Interface (12). In this implementation the multiplication results in a sixteen bit product. Intensity Controller uses the eight most significant bits of each RED, GREEN, and BLUE product as the RED, GREEN, and BLUE outputs respectively to the Light Fixture Interface (12) block with the following exceptions:
If BRIGHTNESS is not zero, and the RED input is not zero, then RED output is the maximum of the eight most significant bits of the RED product or 1.
If BRIGHTNESS is not zero, and the GREEN input is not zero, then GREEN output is the maximum of the eight most significant bits of the GREEN product or 1.
If BRIGHTNESS is not zero, and the BLUE input is not zero, then BLUE output is the maximum of the eight most significant bits of the BLUE product or 1.

### Light Fixture Interface (12)

There will probably be a plethora of electronic control interfaces for lighting until the industry can agree upon a standard. Common interfaces are DMX-512, wireless, and pulse width modulation.

When interfacing to a DMX-512 compatible light fixture the Light Fixture Interface encodes the RED, GREEN, and BLUE inputs to encode serial data bytes to the DMX-512 format. The Light Fixture Interface acts as a DMX-512 master and sends these bytes to a compatible DMX-512 lighting fixture.

When interfacing to a Wireless Controller the Light Fixture Interface encodes the RED, GREEN, and BLUE signals into a format required by the Wireless Controller.

When using pulse width modulation, the Light Fixture Interface uses its respective color inputs, RED, GREEN, and BLUE, to generate RED, GREEN, and BLUE serial bit streams to the RED, GREEN, and BLUE power supplies of the lighting fixture. The fixture uses these bit streams to control the brightness of each color. The bit stream may be electrically isolated in order to directly control the power supplies of lighting fixtures that are not isolated from the AC power line.

### Mode Control (13)

Mode Control responds to scanned inputs of the Control Panel (1) in which no sensors are touched, and inputs from the Color Control (2) that are only possible using more than one finger. Mode Control may use these combinations of inputs to support manufacturing, test. This particular implementation also uses the following combinations for user functions:
RED and CYAN touched: save current outputs of Color Mixer (7), White Level (8), and Brightness Level (10) in non-volatile memory
YELLOW and BLUE touched: load current outputs of Color Mixer (7), White Level (8), and Brightness Level (10) from those that were previously saved to non-volatile memory from executing the RED and CYAN command.
GREEN and MAGENTA touched: load current outputs of Color Mixer (7), White Level (8), and Brightness Level (10) with manufacturer's default values.
Control Panel (1) not touched for a long time: save current outputs of Color Mixer (7), White Level (8), and Brightness Level (10) in non-volatile memory. In the event of a power outage, reload these values as the current outputs of Color Mixer (7), White Level (8) and Brightness Level (10) when power returns. After saving the contents in non-volatile memory the Circuit (5) scans the Control Panel (1) less often in order to save power, and resumes normal scans when a touch on the panel is detected.

I claim:

1. A control panel providing a plurality of input means to a circuit for controlling the emitted color and brightness of one or more multi-colored light sources comprising:
first input means to said circuit for mixing a subset of a plurality of colors;
second input means to said circuit for adding and subtracting white to the color mix of the first means to obtain colors from the light source ranging from saturated to various temperatures of white;
third input means to said circuit for controlling the emitted light intensity of said multi-colored light source.

2. A circuit that interprets the inputs from said control panel of claim 1 comprising:
color mixing control sub-circuit or software directly or indirectly coupled to the first input means of claim 1 for proportionally combining subsets of colors from a set of three or more colors;
white control sub-circuit or software directly or indirectly coupled to the second input means of claim 1 and said color mixing control sub-circuit or software for increasing or decreasing the saturation of the final color emitted by said multi-colored light source;
intensity control sub-circuit or software directly or indirectly coupled to the third input means of claim 1 and said white control sub-circuit or software that proportionally scales each color output of said white control sub-circuit or software to control the brightness of said multi-colored light source;
light fixture interface sub-circuit that converts the result of said intensity control sub-circuit or software into control signals that are compatible for controlling said multi-colored light source.
